(19) United States
(12) Patent Application Publication
(10) Pub. No.: US 2026/0303353 A1
(43) Pub. Date: Oct. 1, 2026

(54) OBTAINING A CONFIGURATOR PUBLIC KEY FOR AUTHENTICATION

(71) Applicant: HEWLETT PACKARD ENTERPRISE DEVELOPMENT LP, Spring, TX (US)

(72) Inventors: Zihan Yan, Beijing (CN); Zhijun Ren, Beijing (CN); Chunfeng Wang, Beijing (CN); Ke Xu, Beijing (CN); Jinzhao Ren, Beijing (CN)

(21) Appl. No.: 19/093,358

(22) Filed: Mar. 28, 2025

(51) Int. Cl. H04L 9/32

(52) U.S. Cl. CPC H04L 9/3236; H04L 9/3273

(57) ABSTRACT

In some examples, an electronic device includes a wireless interface. The electronic device sends, to an access point (AP) through the wireless interface, a first message containing a device identifier of the electronic device, the first message sent by the electronic device to discover a wireless network. The electronic device receives, at the electronic device from the AP, a second message responsive to the first message, the second message containing an encrypted configurator public key. The electronic device decrypts the encrypted configurator public key to generate a decrypted configurator public key. The electronic device uses the decrypted configurator public key in an authentication process between the electronic device and a configurator of the wireless network.

### BACKGROUND

A wireless electronic device can establish a wireless connection with an access point (AP) in a wireless network to communicate with other endpoint devices. To establish the wireless connection, an authentication procedure is performed between the wireless electronic device and the AP.

### BRIEF DESCRIPTION OF THE DRAWINGS

Some implementations of the present disclosure are described with respect to the following figures.

FIG. 1 is a block diagram of an arrangement including enrollee devices, a configurator, a management system, and an enrollee device management repository, according to some examples.

FIG. 2 is a flow diagram of a process that obtains a configurator public bootstrapping key for a mutual authentication process, according to some examples.

FIG. 3 is a block diagram of an electronic device according to some examples.

FIG. 4 is a block diagram of a configurator according to some examples.

FIG. 5 is a block diagram of a storage medium storing machine-readable instructions according to some examples.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

An example of a wireless network is a WI-FI network. For efficient onboarding of large quantities of wireless electronic devices in a WI-FI network, procedures according to the WI-FI Easy Connect Specification can be used. The WI-FI Easy Connect Specification is also referred to as the Device Provisioning Protocol (DPP). A DPP onboarding procedure includes a mutual authentication process in which two devices authenticate one another. The two devices can include a wireless electronic device and an access point (AP) of the WI-FI network. The AP is an access device with which wireless electronic devices can establish wireless connections so that the wireless electronic devices can communicate over the WI-FI network. The devices that engage in the mutual authentication process include an initiator (a first device that sends an authentication request to initiate an authentication process) and responder (a second device that responds to the authentication request from the initiator). The mutual authentication process allows both devices to verify each other's identity, ensuring secure communication.

A wireless electronic device that is to be onboarded using DPP can be referred to as an “enrollee device” (or more simply, an “enrollee”) and the AP (or another network device) of the WI-FI network that onboards the wireless electronic device is referred to as a “configurator device” (or more simply, a “configurator”). Note that either one of the enrollee or the configurator can assume the initiator role while the other assumes the responder role in a mutual authentication process. To perform the mutual authentication process, the initiator and the responder use each other's public bootstrapping key. The initiator has a public bootstrapping key and a private bootstrapping key, which together form the initiator bootstrapping key pair. Similarly, the responder has a public bootstrapping key and a private bootstrapping key, which together form the responder bootstrapping key pair. A wireless electronic device (in its role as either an initiator or responder of the mutual authentication process) can obtain a configurator public bootstrapping key (the public bootstrapping key of the configurator) using any of several techniques. Some of the techniques involve the use of secondary (or out-of-band) communication interfaces of wireless electronic devices, such as a Bluetooth Low Energy (BLE) communication interface or a Near Field Communication (NFC) communication interface. In some cases, a wireless electronic device such as a headless device has a WI-FI communication interface but not a secondary communication interface (such as the BLE or NFC communication interface). As a result, it would not be possible for such a wireless electronic device to obtain the configurator public bootstrapping key using a secondary communication interface. Other techniques to obtain the configurator public bootstrapping key involve the use of the wireless electronic device's user interface, such as a display screen and an input device (e.g., a touchscreen, a keyboard, a pointer device, etc.). A headless device may also not include a user interface, which means that the headless device cannot obtain the configurator public bootstrapping key using a technique that involves a user interface.

If a wireless electronic device is unable to obtain the configurator public bootstrapping key, then a mutual authentication process cannot be performed between the wireless electronic device (enrollee) and the configurator. If the wireless electronic device cannot successfully perform the mutual authentication process, then the wireless electronic device cannot be onboarded in a wireless network. In accordance with some implementations of the present disclosure, systems and techniques are provided to securely obtain configurator bootstrapping keys by wireless electronic devices, such as headless devices or other types of electronic devices. A headless device can refer to an electronic device without certain capabilities, such as a secondary communication interface and/or a user interface.

A “secondary communication interface” is also referred to as an “out-of-band communication interface” that is in addition to a primary wireless interface of the electronic device, where the primary wireless interface is used to communicate with an AP of a wireless network. A “user interface” refers to an interface useable by a user of the electronic device to input and/or output information with respect to the electronic device. The user interface may include any or some combination of the following: a display screen, an input device such as a touchscreen, a keyboard, or a pointer device, or any other component through which a user can input information into the electronic device or receive information from the electronic device.

In some examples of the present disclosure, an electronic device sends, to an AP through a wireless interface of the electronic device, a first message containing a device identifier of the electronic device, where the first message is sent by the electronic device to discover a wireless network. The electronic device receives, from the AP, a second message responsive to the first message, the second message containing an encrypted configurator public bootstrapping key. The electronic device decrypts the encrypted configurator public bootstrapping key to generate a decrypted configurator public bootstrapping key, and the electronic device uses the decrypted configurator public bootstrapping key in the DPP authentication process between the electronic device and a configurator of the wireless network.

A “bootstrapping key” can refer to a cryptographic key that is used for security operations, including authentication of devices. For example, bootstrapping keys can be used to perform a mutual authentication process between an enrollee and a configurator. The bootstrapping keys can be used to derive other secrets, such as a symmetric encryption key, for encrypting and decrypting information in the mutual authentication process.

A “public” bootstrapping key for a first device can be shared with a second device. For example, an enrollee public bootstrapping key can be shared with a configurator, and the configurator public bootstrapping key can be shared with the enrollee. The public bootstrapping key can be part of a bootstrapping key pair that further includes a private bootstrapping key. A “private” bootstrapping key for a device is kept at the device and is not shared with another device.

A “configurator” refers to a device (or a collection of devices) that onboards another device (an “enrollee”) to use resources of a network, including a wireless network such as a WI-FI network. In other examples, the configurator can onboard a device for other types of wireless networks. Onboarding an enrollee for a wireless network includes setting up (provisioning) the enrollee so that the enrollee is able to use the resources of the wireless network. The onboarding includes an authentication process in which a first device can verify the identity of a second device. A mutual authentication process allows both the first and second devices to verify one another's identities.

In some examples of the present disclosure, systems and techniques improve computer functionality or the relevant technology of wireless communications by allowing enrollee devices with restricted functionalities to obtain, in a secure manner, configurator public bootstrapping keys for authentication processes. The configurator public bootstrapping keys can be obtained without using secondary communication interfaces and/or user interfaces of enrollee devices. By sending an encrypted configurator public bootstrapping key from a configurator to an enrollee device, the configurator public bootstrapping key is protected against exposure or tampering. When sending the configurator public bootstrapping key to different enrollee devices, the configurator public bootstrapping key is encrypted using different encryption keys for the different enrollee devices, so that the configurator public bootstrapping key is protected against tampering even when multiple enrollee devices are connected to the same configurator. In some examples, the transfer of the encrypted configurator public bootstrapping key can be performed without having to revise the relevant protocols, such as the DPP or other similar protocol relating to onboarding devices.

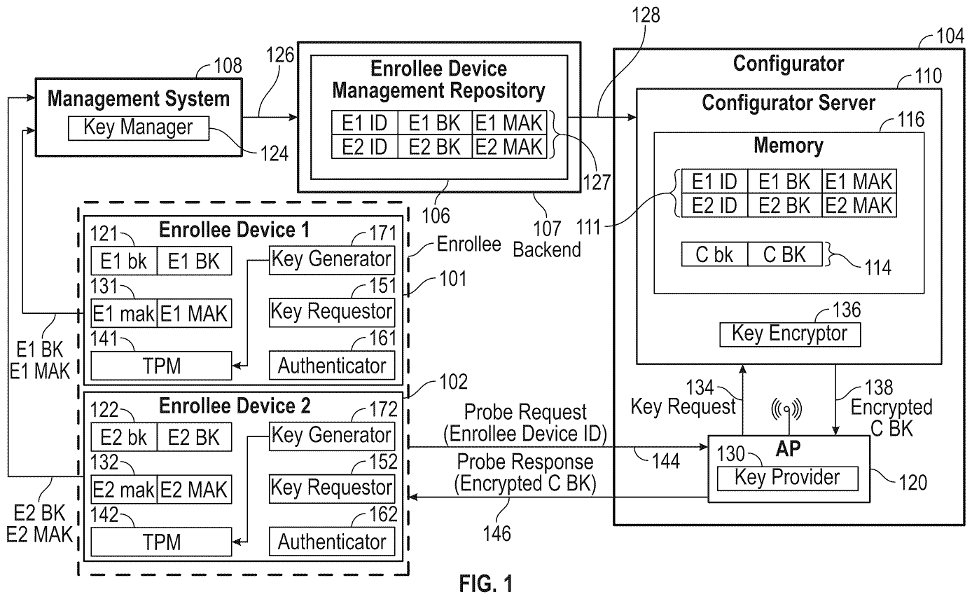

FIG. 1 is a block diagram of an example arrangement that includes enrollee devices 101 and 102, a configurator 104, an enrollee device management repository 106, and a management system 108 that is associated with a manufacturer or another provider (e.g., a distributor, a retailer, a service provider, etc.) of the enrollee devices 101 and 102. Although two enrollee devices are shown in FIG. 1, a different quantity of enrollee devices may be present in other examples.

In some examples, if the management system 108 is associated with a manufacturer of the enrollee devices 101 and 102, the management system 108 may be located at a factory or other facility of the manufacturer. During the manufacture of an enrollee device, the management system 108 can connect to the enrollee device to receive specific information (including keys as discussed further below) from the enrollee device. More generally, the management system 108 is responsible for obtaining specific information of an enrollee device in a secure environment. The management system 108 can be implemented with one or more computers.

The enrollee device management repository 106 can be implemented with one or more storage devices. The enrollee device management repository 106 can be part of a backend environment 107 (e.g., a cloud environment, a data center, or any other remotely accessible computing environment) that is accessible to the configurator 104 over a network, such as a local area network (LAN), a wide area network (WAN), a public network, or another type of network. Although shown as separate from the management system 108, the enrollee device management repository 106 may be part of the management system 108 in other examples.

The configurator 104 includes an AP 120 of a wireless network. In some examples, the wireless network is a Wi-Fi network. In other examples, the wireless network can be a different type of wireless network.

In some examples, the configurator 104 further includes a configurator server 110, which may be part of a cloud environment, a data center, a server computing environment, or any other type of computing environment accessible to the AP 120. Although just one AP is shown in FIG. 1, in other examples, multiple APs may be present in the wireless network.

In further examples, the functionalities of the configurator server 110 may be integrated into the AP 120. More generally, the configurator 104 can include one or more devices, which can include just the AP 120 alone or the AP 120 in combination with the configurator server 110.

Each enrollee device 101 or 102 can create cryptographic keys for the enrollee device 101 or 102. Specifically, the enrollee device 101 includes a key generator 171 to create cryptographic keys for the enrollee device 101, and the enrollee device 102 includes a key generator 172 to create cryptographic keys for the enrollee device 102. In some examples, the cryptographic keys that can be produced by each enrollee devices 101 or 102 include bootstrapping keys and mutual authentication keys. As noted above, a bootstrapping key is used in a mutual authentication process between an enrollee and the configurator 104. A mutual authentication key is a key that is used to encrypt or decrypt a bootstrapping key.

The key generator 171 in the enrollee device 101 can create an enrollee bootstrapping key pair 121 and an enrollee mutual authentication key pair 131 for the enrollee device 101. The enrollee bootstrapping key pair 121 includes an enrollee private bootstrapping key, represented as Enrollee 1 bk (E1 bk), and an enrollee public bootstrapping key, represented as Enrollee 1 BK (E1 BK). The enrollee mutual authentication key pair 131 includes an enrollee private mutual authentication key, represented as E1 mak, and an enrollee public mutual authentication key, represented as E1 MAK.

The generator 172 in the enrollee device 102 can create an enrollee bootstrapping key pair 122 and an enrollee mutual authentication key pair 132 for the enrollee device 102. The enrollee bootstrapping key pair 122 includes an enrollee private bootstrapping key, represented as E2 bk, and an enrollee public bootstrapping key, represented as E2 BK. The enrollee mutual authentication key pair 132 includes an enrollee private mutual authentication key, represented as E2 mak, and an enrollee public mutual authentication key, represented as E2 MAK.

The enrollee bootstrapping key pair 121 and the mutual authentication key pair 131 are stored by the key generator 171 in a secure storage of the enrollee device 101. The secure storage may include a memory in a security processor of the enrollee device. An example of a security processor is a Trusted Platform Module (TPM). Thus, the key pairs 121 and 131 may be stored in a TPM 141 of the enrollee device 101.

Similarly, the enrollee bootstrapping key pair 122 and the mutual authentication key pair 132 are stored by the key generator 172 in a secure storage of the enrollee device 102, such as in a TPM 142 of the enrollee device 102.

A security processor is used by an enrollee device for performing security operations in the enrollee device. A security processor (sometimes referred to as a security cryptoprocessor) can perform various hardware-based, security functions in a physical platform. The security functions of the security processor can include key and certificate management and generation. For example, the security processor can use and securely store cryptographic keys used in security operations.

When the enrollee device 101 is securely connected to the management system 108, the enrollee device 101 can send E1 BK and E1 MAK to the management system 108. Similarly, when the enrollee device 102 is securely connected to the management system 108, the enrollee device 102 can send E2 BK and E2 MAK to the management system 108. An enrollee device can send the public keys to the management system 108 either at the request of a key manager 124 in the management system 108, or based on the enrollee device pushing the public keys to the management system 108. The secure connection between the management system 108 and the enrollee device can be a wired connection or a wireless connection. A connection is secure if the connection is protected against unauthorized access or tampering.

In some examples, the key manager 124 can send (at 126) the enrollee public keys obtained by the key manager 124 to the enrollee device management repository 106. The enrollee public keys when stored in the enrollee device management repository 106 are available to other entities, including the configurator 104. Specifically, the key manager 124 sends (at 126) enrollee public keys (e.g., E1 BK, E1 MAK, E2 BK, and E2 MAK) to store in the enrollee device management repository 106. In addition, the key manager 124 sends (at 126) enrollee identifiers (IDs), including E1 ID (which identifies the enrollee device 101) and E2 ID (which identifies the enrollee device 102), to the enrollee device management repository 106. E1 ID may be calculated by the key generator 171 in the enrollee device 101 and provided to the key manager 124, and E2 ID may be calculated by the key generator 172 in the enrollee device 102 and provided to the key manager 124. Alternatively or additionally, the key manager 124 can also calculate E1 ID and E2 ID as discussed further below.

The enrollee IDs and enrollee public keys can be stored in a data structure 127, which can be in the form of a table, a list, or another data structure. The data structure 127 can have multiple entries, including a first entry containing E1 ID, E1 BK, and E1 MAK, and a second entry containing E2 ID, E2 BK, and E2 MAK. The data structure 127 may contain other entries for other enrollee devices.

The configurator server 110 can obtain (at 128) enrollee device information in the data structure 127 according to either a pull transfer or push transfer. With a pull transfer, the configuration server 110 sends a request for enrollee public keys to the enrollee device management repository 106, which responds to the request by sending the enrollee public keys (as well as corresponding enrollee IDs) to the configurator server 110. Alternatively, with a push transfer, the enrollee device management repository 106 can push the enrollee public keys (as well as corresponding enrollee IDs) to the configurator server 110 when the enrollee device management repository 106 receives the enrollee public keys.

The enrollee device information obtained from the enrollee device management repository 106 can be stored in a data structure 111 that is similarly formatted as the data structure 127.

Using the arrangement of FIG. 1 according to some examples, an enrollee device (either the enrollee device 101 or 102, for example) can obtain a configurator public bootstrapping key, represented as C BK, for use in a mutual authentication process between the enrollee and the configurator 104. The configurator public bootstrapping key can be obtained over the primary interface (e.g., a WI-FI interface) of the enrollee device. As a result, the enrollee device does not have to rely on use of a secondary communication interface or a user interface, which may not be available at the enrollee device, to obtain the configurator public bootstrapping key.

The configurator public bootstrapping key, C BK, is part of a configurator bootstrapping key pair 114 stored by the configurator server 110 in a memory 116 of the configurator server 110. The configurator bootstrapping key, Configurator BK, is part of a configurator bootstrapping key pair 114 that also includes a configurator private bootstrapping key, represented as C bk.

As further shown in FIG. 1, an enrollee device includes a key requester to send a request for the configurator public bootstrapping key, C BK, and an authenticator to perform an authentication process, such as a mutual authentication process between the enrollee and the configurator 104. The enrollee device 101 includes a key requester 151 and an authenticator 161, and the enrollee device 102 includes a key requester 152 and an authenticator 162.

The AP 120 includes a key provider 130 to provide the configurator public bootstrapping key, C BK, in response to a request from an enrollee device. For example, in FIG. 1, an enrollee device (101 or 102) can send (at 144) a Probe request to the AP 120 in the configurator 104.

In response to the Probe request from the enrollee device, the key provider 130 can send a key request 134 to the configurator server 110, which retrieves, from the memory 116, the configurator public bootstrapping key, C BK. A key encryptor 136 in the configurator server 110 encrypts C BK to produce Encrypted C BK 138. The configurator server 110 sends Encrypted C BK 138 to the AP 120 for transmission to the enrollee device that sent the request for the configurator public bootstrapping key. For example, the AP 120 can send (at 146) a Probe response containing Encrypted C BK.

In further examples, other messages aside from a Probe request and a Probe response may be exchanged between an enrollee device and the configurator 104. Other messages may include other types of management messages used to perform control activities between enrollee devices and the configurator 104. Also, alternatively, in examples where the AP 120 and the configurator server 110 are integrated together in a system, the key request 134 and Encrypted C BK 138 may include internal exchanges of information within the system.

During a mutual authentication process, the bootstrapping keys are used by the enrollee and the configurator to establish trust and a secure channel. Private bootstrapping keys (e.g., the enrollee private bootstrapping key, E1 bk or E2 bk, and the configurator private bootstrapping key, C bk) are used to generate session keys and protect authentication information.

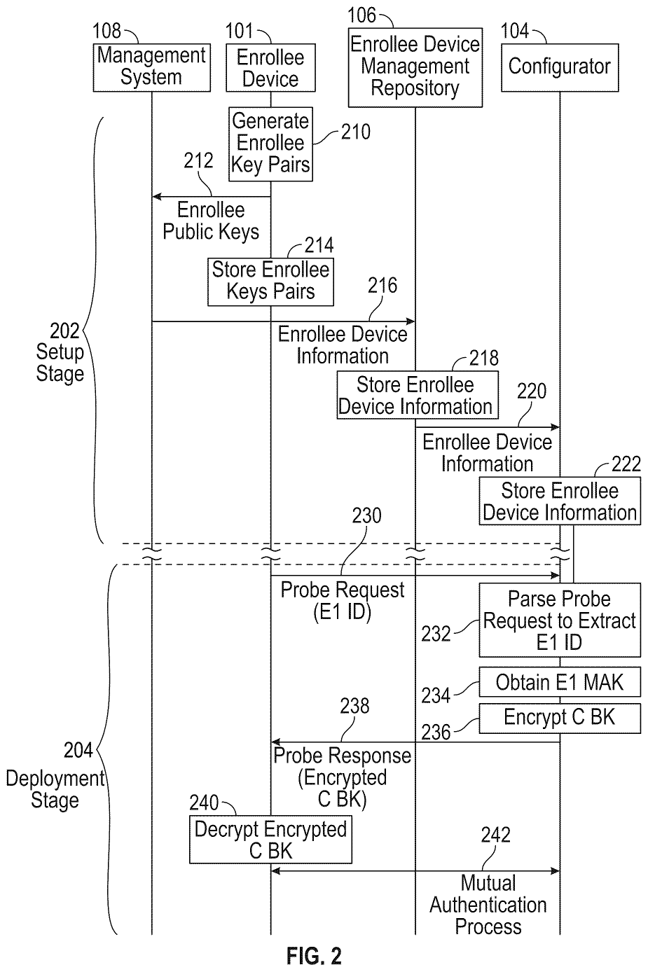

The following discussion refers to both FIG. 1 and FIG. 2. FIG. 2 is a flow diagram of a process involving the management system 108, the enrollee device management repository 106, the enrollee device 101, and the configurator 104. A similar process can be performed in conjunction with the enrollee device 102 (or any other enrollee device). FIG. 2 shows tasks performed in a specific order. In other examples, the tasks may be performed in a different order, some of the tasks may be omitted, and other tasks may be added.

The process of FIG. 2 includes a setup stage 202 and a deployment stage 204. The setup stage 202 may be performed during the manufacture of or another initial phase associated with the enrollee device 101. The deployment stage 204 is performed after the enrollee device 101 has been deployed to a site at which the enrollee device 101 is to be placed into operation. The setup stage 202 includes tasks 210 to 222. The deployment stage 204 includes tasks 230 to 242.

The key generator 171 in the enrollee device 101 generates (at 210) enrollee key pairs for the enrollee device 101, including the enrollee bootstrapping key pair 121 and the enrollee mutual authentication key pair 131. The enrollee device 101 sends (at 212) the enrollee public keys (E1 BK and E1 MAK) to the management system 108 over a secure connection. The enrollee device 101 stores (at 214) the enrollee key pairs in the TPM 141.

The key manager 124 in the management system 108 sends (at 216) enrollee device information for the enrollee device 101 to the enrollee device management repository 106, which stores (at 218) the received enrollee device information, such as in the data structure 127. The enrollee device information includes the enrollee public keys (E1 BK and E1 MAK). In addition, the enrollee device information includes an enrollee device identifier (ID) created for the enrollee device 101. This enrollee device ID of the enrollee device 101 is referred to as E1 ID. E1 ID uniquely identifies the enrollee device 101, and is different from a device ID of any other enrollee device. For example, the device ID of the enrollee device 102 is E2 ID, which is different from E1 ID. In some examples, E1 ID may be created by the key generator 171 in the enrollee device 101 and provided to the key manager 124. Similarly, E2 ID may be created by the key generator 172 in the enrollee device 102 and provided to the key manager 124. Alternatively or additionally, the key manager 124 can also calculate E1 ID and E2 ID.

In some examples, E1 ID is based on a function applied on the enrollee public bootstrapping key, E1 BK. The function can include a cryptographic hash function, such as a Secure Hash Algorithm (SHA) hash function, a Message Digest (MD5) algorithm, or another cryptographic hash function. In further examples, E1 ID can be derived by applying the function on the enrollee public bootstrapping key, E1 BK, and other information, such as a nonce (a random number).

The configurator server 110 of the configurator 104 obtains (at 220) the enrollee device information for the enrollee device 101 from the enrollee device management repository 106. The configurator server 110 stores (at 222) the obtained enrollee device information (including E1 ID, E1 BK, and E1 MAK) in the memory 116 of the configurator server 110. For example, E1 ID, E1 BK, and E1 MAK can be added as an entry to the data structure 111.

In the deployment stage 204, the enrollee device 101 can send (at 230) a request to the configurator 104 for obtaining the configurator public bootstrapping key, C BK. In some examples, the request includes a management message sent to the AP 120 of the configurator 104. The management message can be a management message according to the Institute of Electrical and Electronics Engineers (IEEE) 802.11 standard, for example. More specifically, the request can include a Probe request that contains E1 ID. An IEEE 802.11 Probe request is sent by an electronic device to discover a wireless network within range of the electronic device. The Probe request can also advertise capabilities of the electronic device, including a supported data rate and other capabilities. An AP within the range of the electronic device that receives the Probe request can issue a Probe response that is sent to the electronic device.

As noted above, E1 ID can be a hash value derived by applying a hash function on the enrollee public bootstrapping key, E1 BK. By using the hash value as E1 ID instead of directly including E1 BK in the Probe request, device privacy can be protected while maintaining enrollee identifier uniqueness and improving security. In addition, the length of the hashed enrollee identifier is fixed so that storing and transmitting the hashed enrollee identifier is more efficient.

In some examples, the Probe request includes a vendor specific element, which includes various fields including a field for an enrollee device ID. According to the IEEE 802.11-2020 Specification, Section 9.4.2.25, for example, the vendor specific element is used to carry information not defined in the IEEE 802.11 standard. The vendor specific element may have the following format:

| | | | |
|---|---|---|---|
| Element ID | Length | Organization | Vendor Specific |
| | | Identifier | Content |

The Element ID field has a specified value defined by the IEEE 802.11 standard to indicate the vendor specific element. The Length field indicates a length of the vendor specific element, excluding the Element ID and Length fields. The Organization Identifier field identifies the entity (e.g., business organization or another type of organization) that has defined the content for the vendor specific element.

In accordance with some examples of the present disclosure, the Vendor Specific Content field contains an enrollee device ID (e.g., E1 ID) of an enrollee device, and encryption algorithm information specifying the encryption algorithm to be used by the configurator 104 when encrypting data, including the configurator public bootstrapping key, C BK. The encryption algorithm can be selected based on mutual capabilities and preferences of the enrollee and the configurator 104. Some examples of encryption algorithms include any or some combination of the following: Elliptic Curve Integrated Encryption Scheme (ECIES) algorithm, Rivest-Shamir-Adleman (RSA) algorithm, or another encryption algorithm.

In other examples, vendor specific elements in messages can have other formats defined by other standards, open-source protocols, or proprietary protocols. More generally, the request for the configurator public bootstrapping key, C BK, sent by an enrollee device can be a management frame, such as a Probe request according to IEEE 802.11, containing a vendor specific element including the enrollee device ID.

The key provider 130 in the AP 120 parses (at 232) the Probe request and extracts E1 ID and the information of the encryption algorithm from the vendor specific element in the Probe request. The key provider 130 can send the key request 134 to the configurator server 110, where the key request 134 contains the extracted E1 ID and encryption algorithm information.

Based on E1 ID, the configurator server 110 obtains (at 234) the enrollee public mutual authentication key, E1 MAK, for the enrollee device 101 identified by E1 ID. Note that the memory 116 stores multiple enrollee public mutual authentication keys for different enrollee devices. The multiple enrollee public mutual authentication keys may be stored in the data structure 111, which has multiple entries that correlate different enrollee IDs to respective enrollee public keys. E1 ID can be used to perform a lookup of the data structure to retrieve the entry of the data structure 111 containing the enrollee public mutual authentication key, E1 MAK, correlated to E1 ID in the data structure 111.

The key encryptor 136 in the configurator server 110 encrypts (at 236) C BK with E1 MAK using the encryption algorithm specified by the encryption algorithm information in the key request 134. The configurator server 110 sends Encrypted C BK to the AP 120. The key provider 130 in the AP 120 sends (at 238) a Probe response to the enrollee device 101, where the Probe response includes Encrypted C BK.

The Probe response can include a vendor specific element, such as according to IEEE 802.11-2020. The format of the vendor specific element in the Probe response is similar to the format of the vendor specific element in the Probe request, except the vendor specific content in the Probe response contains the encrypted configurator public bootstrapping key, Encrypted C BK.

By using vendor specific elements in messages to communicate enrollee device IDs and the encrypted configurator public bootstrapping key, different vendors (e.g., manufacturers or other entities) can customize data fields to carry the information in different ways, which enhances flexibility and allows ease of support for protocols (e.g., DPP) that define communication exchanges to onboard enrollee devices.

The key requester 151 in the enrollee device 101 decrypts (at 240) Encrypted C BK using the enrollee private mutual authentication key, E1 mak, which is retrieved from the TPM 141 in the enrollee device 101. The decryption uses the encryption algorithm specified in the encryption algorithm information of the Probe request sent by the enrollee device 101. The decryption produces a decrypted version of Encrypted C BK, which is referred to as Decrypted C BK. Decrypted C BK is the configurator public bootstrapping key that is to be used by the enrollee device 101 in a mutual authentication process with the configurator 104. The authenticator 161 in the enrollee device 101 can perform the mutual authentication process (at 242) by sending a message to the configurator 104. In examples where the mutual authentication process is part of a DPP exchange, the message sent can include a DPP Presence Announcement indicating the readiness of the enrollee device 101 to engage in the mutual authentication process.

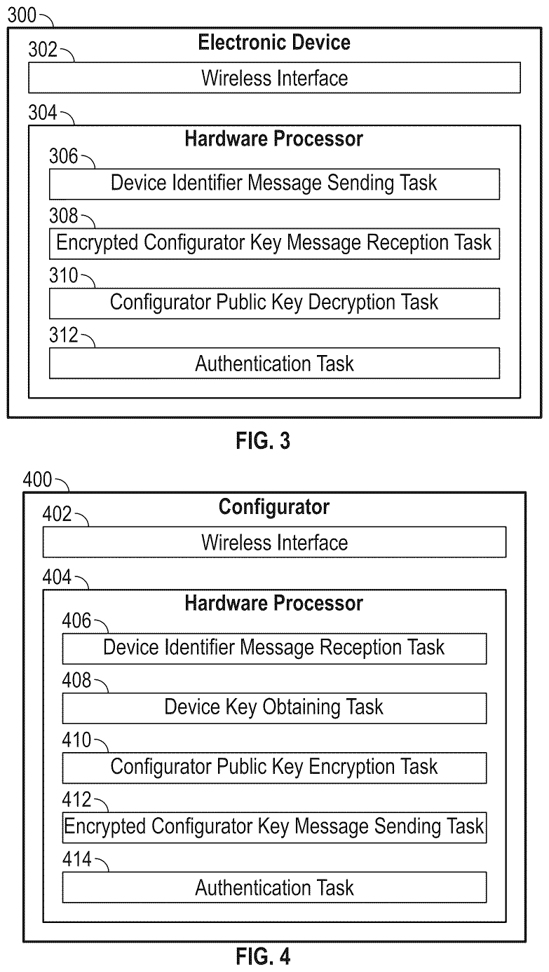

FIG. 3 is a block diagram of an electronic device 300 according to some examples of the present disclosure. The electronic device 300 is an example of the enrollee device 101 or 102 of FIG. 1.

The electronic device 300 includes a wireless interface 302, such as a WI-FI interface to communicate over a WI-FI network or another type of wireless interface to communicate over another type of wireless network. A wireless interface can include a signal transceiver to transmit and receive wireless signals, and one or more protocol layers to manage communications according to one or more respective communication protocols.

The electronic device 300 includes a hardware processor 304 (or multiple hardware processors). A hardware processor can include a microprocessor, a core of a multi-core microprocessor, a microcontroller, a programmable integrated circuit, a programmable gate array, or another hardware processing circuit.

The hardware processor 304 can perform various tasks. A hardware processor performing a task can refer to a single hardware processor performing the task or multiple hardware processors performing the task.

The tasks of the hardware processor 304 may be performed by machine-readable instructions executed on the hardware processor 304. Alternatively or additionally, the tasks of the hardware processor 304 can be performed by hardware circuitry of the hardware processor 304.

The tasks of the hardware processor 304 include a device identifier message sending task 306 to send, to an AP through the wireless interface 302, a first message containing a device identifier of the electronic device, the first message sent by the electronic device to discover a wireless network. In some examples, the first message includes an IEEE 802.11 Probe request. In other examples, the first message can include a different management message.

The tasks of the hardware processor 304 include an encrypted configurator key message reception task 308 to receive, at the electronic device from the AP, a second message responsive to the first message, the second message containing an encrypted configurator public key. The encrypted configurator public key can be produced by encrypting the configurator public key with an enrollee public mutual authentication key, for example. In some examples, the second message includes an IEEE 802.11 Probe response. In other examples, the second message can include a different management message.

The tasks of the hardware processor 304 include a configurator public key decryption task 310 to decrypt the encrypted configurator public key to generate a decrypted configurator public key. The decryption can use an enrollee private mutual authentication key, for example.

The tasks of the hardware processor 304 include an authentication task 312 to use the decrypted configurator public key in an authentication process (e.g., the DPP authentication process) between the electronic device and a configurator of the wireless network. The authentication process may include a mutual authentication process, for example.

In some examples, the device identifier is based on an enrollee public key of the electronic device. The enrollee public key can be an enrollee public bootstrapping key.

In some examples, the device identifier is based on a hash value derived from a hash function applied on the enrollee public key of the electronic device.

In some examples, the encrypted configurator public key is generated by encrypting a configurator public key with an enrollee public mutual authentication key of the electronic device.

In some examples, the electronic device 300 decrypts the encrypted configurator public key using an enrollee private mutual authentication key of the electronic device.

In some examples, the device identifier is included in a vendor specific element of a management message, such as an IEEE 802.11 Probe request.

In some examples, the vendor specific element of the management message further includes information specifying a type of encryption algorithm to use at the configurator to encrypt the configurator public bootstrapping key.

In some examples, the device identifier in the first message distinguishes the electronic device from another electronic device associated with a different device identifier.

In some examples, the electronic device is without a secondary communication interface and without a user interface.

FIG. 4 is a block diagram of a configurator 400 according to some examples of the present disclosure. The configurator 104 of FIG. 1 is an example of the configurator 400. The configurator 400 can be implemented with one or more devices, such as the AP 120 and the configurator server 110 of FIG. 1. In other examples, the configurator 400 is implemented with one device that combines the functionalities of the AP 120 and the configurator server 110.

The configurator 400 includes a wireless interface 402 to communicate wirelessly with an electronic device. The configurator 400 also includes a hardware processor 404 (or multiple hardware processors) to perform various tasks. The tasks of the hardware processor 404 may be performed by machine-readable instructions executed on the hardware processor 404. Alternatively or additionally, the tasks of the hardware processor 404 can be performed by hardware circuitry of the hardware processor 404.

The tasks of the hardware processor 404 include a device identifier message reception task 406 to receive, through the wireless interface 402, a first message containing a device identifier of the electronic device. The first message is sent by the electronic device to discover a wireless network.

The tasks of the hardware processor 404 include a device key obtaining task 408 to, in response to the first message, obtain a first key correlated to the device identifier. The first key can be an enrollee public mutual authentication key for the electronic device, for example.

The tasks of the hardware processor 404 include a configurator public key encryption task 410 to encrypt a configurator public key with the first key to derive an encrypted configurator public key. The configurator public key that is encrypted can be a configurator public bootstrapping key, for example.

The tasks of the hardware processor 404 include an encrypted configurator key message sending task 412 to send, through the wireless interface 402, a second message containing the encrypted configurator public key to the electronic device.

The tasks of the hardware processor 404 include an authentication task 414 to perform an authentication process with the electronic device based on a decrypted version of the encrypted configurator public key.

In some examples, the configurator 400 includes a memory to store a data structure (e.g., 111 in FIG. 1) including entries correlating different device identifiers to corresponding keys (e.g., enrollee public bootstrapping keys and enrollee public mutual authentication keys). The hardware processor 404 looks up the first key by accessing the data structure using the device identifier in the first message.

In some examples, the data structure is populated from a data repository (e.g., 106 in FIG. 1) to which a management system (e.g., 108 in FIG. 1) sends enrollee device information of respective electronic devices, where the enrollee device information of the electronic device includes the device identifier of the electronic device and the first key.

In some examples, the first key is a public key for the electronic device, and the decrypted version of the encrypted configurator public key is based on a decryption of the encrypted configurator public key at the electronic device using a private key corresponding to the public key.

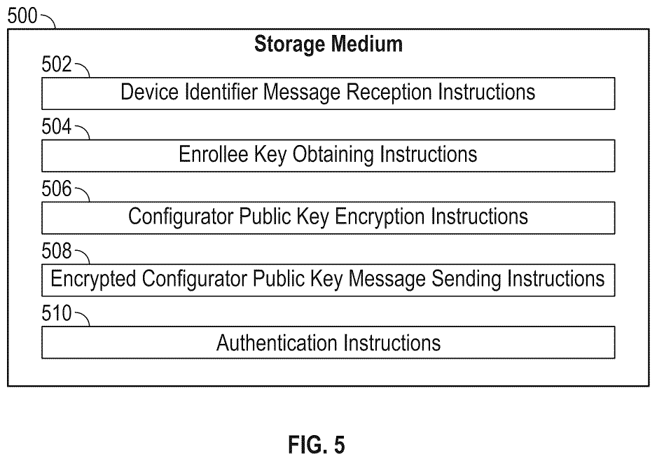

FIG. 5 is a block diagram of a non-transitory machine-readable or computer-readable storage medium 500 storing machine-readable instructions that upon execution cause a configurator (e.g., 104 in FIG. 1) to perform various tasks.

The machine-readable instructions include device identifier message reception instructions 502 to receive a first message sent by an electronic device to discover a wireless network. The first message contains a device identifier of the electronic device and encryption algorithm information specifying an encryption algorithm to be used by the configurator.

The machine-readable instructions include enrollee key obtaining instructions 504 to, in response to the first message, obtain an enrollee key correlated to the device identifier. The enrollee key can be an enrollee public mutual authentication key. The enrollee key can be obtained by performing a lookup of a data structure (e.g., 111 in FIG. 1) using the device identifier to retrieve an entry containing the enrollee key.

The machine-readable instructions include configurator public key encryption instructions 506 to encrypt a configurator public key with the enrollee key using the encryption algorithm specified by the encryption algorithm information to derive an encrypted configurator public key.

The machine-readable instructions include encrypted configurator public key message sending instructions 508 to send a second message containing the encrypted configurator public key through a wireless interface to the electronic device.

The machine-readable instructions include authentication instructions 510 to perform an authentication process with the electronic device based on a decrypted version of the encrypted configurator public key. The authentication process can be a mutual authentication process.

In some examples, the enrollee key is an enrollee mutual authentication key for the electronic device, and the device identifier is based on an enrollee bootstrapping key for the electronic device.

As used here, an electronic device can refer to any or some combination of the following: an Internet-of-Things (IoT) device, a handheld appliance, or any other electronic device that has a primary wireless interface (e.g., a WI-FI interface) but that is without a secondary communication interface and/or a user interface.

A memory can be implemented with one or more memory devices, such as dynamic random access memory (DRAM) devices, static random access memory (SRAM) devices, flash memory devices, erasable and programmable read-only memory (EPROM) devices, electrically erasable and programmable read-only memory (EEPROM) devices, or other types of memory devices.

The key manager 124, key provider 130, key encryptor 136, key generator 171 or 172, key requester 151 or 152, and authenticator 161 or 162 of FIG. 1 may be implemented with machine-readable instructions executable by processing resources of respective devices. Alternatively, any of the foregoing components may be implemented with hardware. A processing resource can include one or more hardware processors.

A storage medium (e.g., 500 in FIG. 5) can include any or some combination of the following: a semiconductor memory device such as a dynamic or static random access memory (a DRAM or SRAM), an erasable and programmable read-only memory (EPROM), an electrically erasable and programmable read-only memory (EEPROM), or a flash memory; a magnetic disk such as a fixed, floppy and removable disk; another magnetic medium including tape; an optical medium such as a compact disk (CD) or a digital video disk (DVD); or another type of storage device. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the present disclosure, use of the term “a,” “an,” or “the” is intended to include the plural forms as well, unless the context clearly indicates otherwise. Also, the term “includes,” “including,” “comprises,” “comprising,” “have,” or “having” when used in this disclosure specifies the presence of the stated elements, but do not preclude the presence or addition of other elements.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. An electronic device comprising:
a wireless interface; and
a hardware processor to:
send, to an access point (AP) through the wireless interface, a first message containing a device identifier of the electronic device, the first message sent by the electronic device to discover a wireless network;
receive, at the electronic device from the AP, a second message responsive to the first message, the second message containing an encrypted configurator public key;
decrypt the encrypted configurator public key to generate a decrypted configurator public key; and
use the decrypted configurator public key in an authentication process between the electronic device and a configurator of the wireless network.

2. The electronic device of claim 1, wherein the device identifier is based on an enrollee public key of the electronic device.

3. The electronic device of claim 2, wherein the device identifier is based on a hash value derived from a hash function applied on the enrollee public key of the electronic device.

4. The electronic device of claim 1, wherein the encrypted configurator public key is generated by encrypting a configurator public key with a public mutual authentication key of the electronic device.

5. The electronic device of claim 4, wherein the hardware processor is to:
decrypt the encrypted configurator public key using a private mutual authentication key of the electronic device.

6. The electronic device of claim 1, wherein the first message comprises a management message according to an Institute of Electrical and Electronics Engineers (IEEE) 802.11 standard.

7. The electronic device of claim 6, wherein the device identifier is included in a vendor specific element of the management message.

8. The electronic device of claim 7, wherein the vendor specific element of the management message further includes information specifying a type of encryption algorithm to use at the configurator to encrypt a configurator public key.

9. The electronic device of claim 1, wherein the device identifier in the first message distinguishes the electronic device from another electronic device associated with a different device identifier.

10. The electronic device of claim 1, wherein the first message comprises a Probe request, and the second message comprises a Probe response.

11. The electronic device of claim 1, wherein the second message comprises a management message according to an Institute of Electrical and Electronics Engineers (IEEE) 802.11 standard, and wherein the encrypted configurator public key is included in a vendor specific element of the management message.

12. The electronic device of claim 1, wherein the electronic device is without a secondary communication interface and without a user interface.

13. The electronic device of claim 1, wherein the AP is part of the configurator.

14. A configurator comprising:
a wireless interface to communicate wirelessly with an electronic device; and
a hardware processor to:
receive, through the wireless interface, a first message containing a device identifier of the electronic device, the first message sent by the electronic device to discover a wireless network;
in response to the first message, obtain a first key correlated to the device identifier;
encrypt a configurator public key with the first key to derive an encrypted configurator public key;
send, through the wireless interface, a second message containing the encrypted configurator public key to the electronic device; and
perform an authentication process with the electronic device based on a decrypted version of the encrypted configurator public key.

15. The configurator of claim 14, comprising:
a memory to store a data structure comprising entries correlating different device identifiers to corresponding keys,
wherein the hardware processor is to look up the first key by accessing the data structure using the device identifier in the first message.

16. The configurator of claim 15, wherein the data structure is populated from a data repository to which a management system sends enrollee device information of respective electronic devices, wherein the enrollee device information of the electronic device includes the device identifier of the electronic device and the first key.

17. The configurator of claim 16, wherein the first key is an enrollee mutual authentication key, and the enrollee device information of the electronic device further includes an enrollee bootstrapping key used by the configurator in the authentication process.

18. The configurator of claim 14, wherein the first key is a public key for the electronic device, and the decrypted version of the encrypted configurator public key is based on a decryption of the encrypted configurator public key at the electronic device using a private key corresponding to the public key.

19. A non-transitory machine-readable storage medium comprising instructions that upon execution cause a configurator to:
receive a first message sent by an electronic device to discover a wireless network, the first message containing a device identifier of the electronic device and encryption algorithm information specifying an encryption algorithm;
in response to the first message, obtain an enrollee key correlated to the device identifier;
encrypt a configurator public key with the enrollee key using the encryption algorithm specified by the encryption algorithm information to derive an encrypted configurator public key;
send a second message containing the encrypted configurator public key through a wireless interface to the electronic device; and
perform an authentication process with the electronic device based on a decrypted version of the encrypted configurator public key.

20. The non-transitory machine-readable storage medium of claim 19, wherein the enrollee key is an enrollee mutual authentication key for the electronic device, and the device identifier is based on an enrollee bootstrapping key for the electronic device.
